(19) United States
(12) Patent Application Publication
(10) Pub. No.: US 2018/0342095 A1
(43) Pub. Date: Nov. 29, 2018

(54) SYSTEM AND METHOD FOR GENERATING VIRTUAL CHARACTERS

(71) Applicant: Motional LLC, Pasadena, CA (US)

(72) Inventor: Mark Walsh, Pasadena, CA (US)

(21) Appl. No.: 15/922,716

(22) Filed: Mar. 15, 2018

Related U.S. Application Data
(60) Provisional application No. 62/472,156, filed on Mar. 16, 2017.

(51) Int. Cl. G06T 13/40; G06N 3/00; G06K 9/00; G06F 3/16

(52) U.S. Cl. CPC G06T 13/40; G06F 3/167; G06K 9/00335; G06N 3/006

(57) ABSTRACT

The system and method for generating a virtual character functions to enable an interface for creating and managing simulated personas that can contextually respond to stimuli. The responses of the virtual character can be set to reflect a particular type of persona. Furthermore, the virtual characters can be driven using the system and method so as to express realistic and responsive representations of a character's thoughts, emotions, and moods. The system and method preferably enable one or more users to provide input that configures and defines a set of operating parameters for a virtual character. The system and method can apply that configuration to drive character actions and behavior within one or more media format.

### CROSS-REFERENCE TO RELATED APPLICATIONS

This patent application claims the benefit of the filing date of U.S. Provisional Patent Application Ser. No. 67/472,156 for “SYSTEM AND METHOD FOR GENERATING VIRTUAL CHARACTERS” filed on Mar. 16, 2017 which is incorporated by reference in its entirety herein.

### TECHNICAL FIELD

This invention relates generally to the field of virtual characters, and more specifically to a new and useful system and method for generating virtual characters.

### BACKGROUND

Recent technical and product developments have introduced virtual reality and augmented reality to a wider number of people. With increased prevalence, more applications are being built for these immersive mediums. However, many of today's applications are built from the perspective of traditional 3D gaming and movies, which are traditionally consumed on a screen. These traditional approaches when applied in an immersive media like VR or AR can create a significant disconnect between the user and the virtual world. As an immersive experience, the user more directly compares the interactions with real life. Interacting with computer-controlled characters in these environments can result in an uncomfortable experience for the user. Thus, there is a need in the virtual character field to create a new and useful system and method for generating virtual characters. This invention provides such a new and useful system and method.

### BRIEF DESCRIPTION OF THE FIGURES

FIG. 1 is a flowchart representation of a method; and

FIG. 2 is a schematic representation of a system of a preferred embodiment.

### DESCRIPTION OF THE EMBODIMENTS

The following description of the embodiments of the invention is not intended to limit the invention to these embodiments but rather to enable a person skilled in the art to make and use this invention.

### 1. Overview

The system and method for generating a virtual character functions to enable an interface for creating and managing simulated personas that can contextually respond to stimuli. The responses of the virtual character can be set to reflect a particular type of persona. Furthermore, the virtual characters can be driven using the system and method so as to express realistic and responsive representations of a character's thoughts, emotions, and moods. The system and method preferably enable one or more users to provide input that configures and defines a set of operating parameters for a virtual character. The system and method can apply that configuration to drive character actions and behavior within one or more media format.

A virtual character can be a visually rendered character within a virtual reality environment, an augmented reality environment, a 3D or 2D game, an application, or any suitable media. The appearance, the movements or animations of the character, the manner of speaking, spoken content, and/or other attributes of a character can be aspects of that virtual character. For example, a virtual character could be a non-playable character within an immersive virtual reality game. In another example, a virtual character may be at least partially controlled by a player—the virtual character could be generated so that a player's avatar exudes a customized persona when the player is not able to express that characters persona. A virtual character could additionally or alternatively be audio based. For example, the personality of an audio-based personal assistant used on a smart phone or as a customer care representative could be at least partially driven by the system and method.

The system and method preferably provide a persona engine that dynamically expresses a customized personality of a virtual character during an interaction. In some variations, user input such as gaze position, facial expression, verbal/text sentiment analysis, speech tone analysis, and/or other inputs can be used to automatically drive animations, verbalizations, and other forms of character behavior. Additionally or alternatively, the system and method can facilitate manifestation of “thought” in a virtual character. Thought can be characterized as the representation of emotions that can alter body language, mood, prosody and other characteristics expressed through a virtual character.

As a first benefit, the system and method can simplify character creation. As a first aspect, the system and method can provide a comprehensive interface for customizing a character. Customization can be exerted through varying levels of control. As an exemplary type high-level manner of control, general personality traits can be set by specifying an archetypical character or referencing a source character. As an exemplary low-level manner of control, specific character animations can be added to a gesture set that will be triggered at appropriate times.

As similar benefit, users of the system and method can easily create fully defined virtual characters with little work. The virtual characters could inherit attributes from one or more characters. Character attribute inheritance and/or procedurally driven character behavior based on customized preferences may be used to create fully realized characters with reduced effort. The illusion of a realistic artificial character can quickly be lost when character behavior exhibits frequent repetition.

As another benefit, the system and method can simplify the process of creating and managing characters with algorithmic or AI-driven “thought” expression. Body language, facial expressions, language, and prosody (e.g., intonation, tone, rhythm, stress) can be automatically driven by a virtual character of the system and method. Additionally, the customization of such “thought AI” can be facilitated by tools provided for character creation.

As another benefit, the system and method can enhance character management. Current technology requires a considerable amount of coordination between writers, artists, directors, animators, and programmers to create a character. Often changes or updating that character can require significant commitment. The system and method can provide a character-defining interface that automatically updates a persona engine utilized by a technical team. A virtual character could be updated in real-time by pushing out new character customization to a game or application.

As another potential benefit, effort in defining a virtual character can be translated to other mediums and/or projects. The behavior of a virtual character within a virtual reality game could be automatically consistent with the same virtual character when expressed in an audio format or in a 2D animated version. Characters can add a lot of value to a media company's IP. One use case of the system and method is to facilitate easier licensing of a character. The character customization through the system and method could be used to enforce rules on the representation of a character in different mediums.

The system and method for generating virtual characters can be used in a variety of media formats. The system and method can be used for virtual or augmented reality experiences, digital assistants, games, movie/TV production, automated phone services, chat bots, and/or other suitable applications.

In one variation, the system and method can be used in combination with additional animation and media creation tools. In one application, the system and method may be used within open user interactions while character behavior, animations, and actions can be driven by other systems in other situations. In another application, the system and method may be used to dynamically modify predefined character actions. For example, if a virtual character is delivering dialogue to a user in a virtual reality environment and the user looks away from the character, the virtual character could dynamically get the user's attention based on the defined persona of the virtual character.

While the system and method may be used for creating and executing one particular virtual character. The system and method could similarly be applied for generating large numbers of customized and potentially unique personas. One or more virtual characters could be procedurally generated using one or more virtual characters to partially define the generated virtual characters. For example, when a game developer wants to create non-playable characters within a virtual village, they may define a set of virtual characters that are used as the archetypical characters found within that city. Generated virtual characters can exhibit some combination of those archetypical characters.

### 2. Method for Generating a Virtual Character

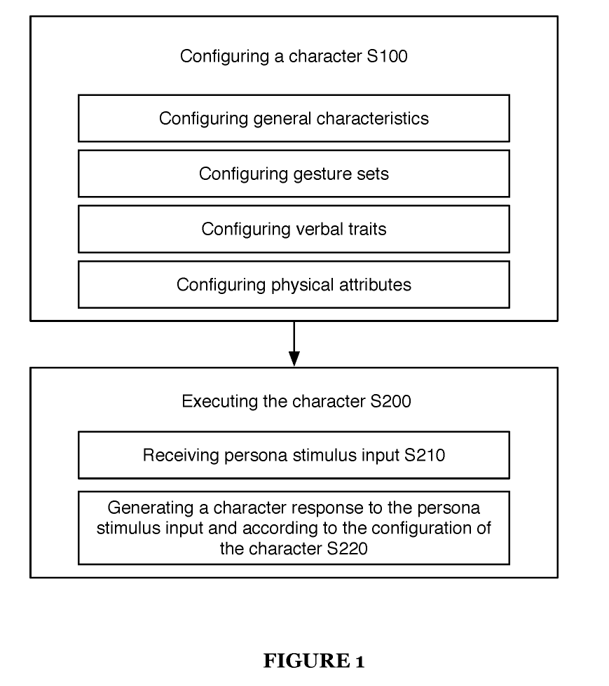

As shown in FIG. 1, a method for providing a customizable virtual persona of a preferred embodiment can include configuring a character S100 and executing the character S200 by receiving persona stimulus input S210 and generating a character response to the persona stimulus input and according to the configuration of the character S220. The method can be used for creating and controlling a virtual character in any suitable digital environment. The method could be used for animating and automating responses of characters within 3D virtual world. The method may alternatively be used in creating automated responses for animated characters. For example, a 2D avatar could have responses driven in part through the persona engine. The method can additionally be used for driving a virtual character that expresses thoughts and emotions in a realistic and responsive manner. A simulated emotional response can be expressed in a virtual character in parallel or merged with the communication of content. For example, the same content may be stated in two different ways depending on the virtual character configuration and/or the situation.

Block S100, which includes configuring a character, functions to setup and/or customize a virtual character. A virtual character is preferably customized through a graphical user interface. In one variation, a graphical user interface is accessed through a web application or a native application. The approach to customization can be manifested in a variety of interfaces. In one approach, a user sets different parameters and options within a dashboard. In another approach, a user may define a virtual character and aspects that make up a persona by selecting pre-populated attributes, gestures, and/or other attributes. A virtual character may additionally or alternatively be configured through a programmatic interface such as an API or a virtual character configuration file.

A user creating or customizing a virtual character is preferably guided through a set of options that can be customized. Configuring a character can include configuring general characteristics, configuring gesture sets, configuring verbal traits, and/or configuring physical attributes.

General attributes can function as defining default virtual character attributes. One general attribute could be selecting an archetypical virtual character. An archetypical virtual character is preferably substantially defined across a variety of emotional and/or situational scenarios. In one implementation, a set of general archetypical characters such as “jock”, “nerd”, “warrior”, “boss”, and/or other general character types can be selected. Alternatively, an archetypical virtual character could be set to another virtual character, which may have been created, by the user or another party. Additionally, a set of archetypical characters could be selected. A resulting set of attributes can be generated by averaging, unioning, interpolating, or combining customization options from the set of archetypical characters. General attributes may alternatively be set by specifying properties of a personality across different dimensions. For example, the temper, energy level, confidence, politeness and/or other persona dimensions could be rated with a numerical value or a classification label.

Configuring gesture sets functions to define visual actions, animations, or motions. The gesture sets preferably provide variations of a character's expressed behavior in response to stimuli. The gesture set could include a set of gestures that relate to different emotional moods and situations. Emotional modes could include shock, confusion, amusement, agreement, fear, concern, insult, anger, distraction, and/or other emotional moods. The situational scenarios may be a set of common scenarios such as instructing another entity, being ignored by another entity, meeting an entity for a first time, having a thought moment, making a realization, getting distracted, being bored, and/or other scenarios. The gesture sets could be populated across the full set of possible emotional and situational combinations.

In one variation, gesture sets could be simply set by selecting from a set of pre-existing possible gesture sets. In another variation, the gesture sets could be set according to a set of parameters. For example, a user may set that a virtual character talks louder when shocked, exaggerates motions when excited, or gets quieter when nervous.

Setting a gesture could additionally include setting a rigging specification, which enables customized gestures to be expressed. The rigging functions as a parametric skeletal representation of character movements. The rigging could then be applied to a rendering of a character in block S200. Additionally, customized rigs may be used for characters that have untraditional skeletal descriptions. The riggings could be manually animated, but could alternatively be motion captured or scanned from a person or face. In some variations, video of a person could be used as a provided gesture. For example, if a user is creating a persona-portrait of him or herself or another, the subject could act out or express different gesture reactions, which can be assembled through the method to create a biographical personal representation.

Configuring verbal traits functions to define spoken phrases and/or vocalization properties for a character. The verbal traits preferably provide variations that can be used depending on a stimulus or intent of the virtual character.

Configuring verbal traits can include receiving pre-scripted response phrases. In one variation, the scripted response phrases can be pre-recorded audio. In another variation, the scripted response phrases can be scripted text. A scripting language could be used to programmatically define variations of a script.

Configuring verbal traits can additionally or alternatively include receiving vocalization response properties, which may be used to alter the voice of a text-to-speech synthesizer. Vocalization response properties could include voice type, speech rate, speech tone, speech volume, and/or other properties. The verbal traits could be set to cover a variety of emotional and situational scenarios in a similar manner to the gesture sets. Verbal traits could be set that relate to different emotional moods and situations. Emotional modes could include shock, confusion, amusement, agreement, fear, concern, insult, anger, distraction, and/or other emotional moods. The situational scenarios may be a set of common scenarios such as instructing another entity, being ignored by another entity, meeting an entity for a first time, having a thought moment, making a realization, getting distracted, being bored, and/or other scenarios. The gesture sets could be populated across the full set of possible emotional and situational combinations.

Configuring physical attributes function to customize properties that relate to the presence of a character. Physical attributes could include gender, age, weight, height, athleticism, and/or other aspects of a character. For example, the weight, height and athleticism aspects could augment the animations of a rigging. The physical attributes may be used to augment other aspects such as physical appearance. Physical appearance may be defined within the method but may alternatively be applied by an outside system if, for example, only the generated rigging of the method is used to control a 3D model.

In one variation, a virtual character could be configured by initializing a new character instantiation. The new character is preferably initialized with a set of defaults. A character could alternatively be initialized from an existing character. For example, a user may have created one virtual character and would like to create an alternate version of the character or build a character using the configuration of that character as the initial defaults. Version history of a character could additionally be enabled so that changes of a character configuration could be managed. In yet another variation, a new virtual character could be initialized from a set of existing virtual configurations. The configurations of the set of virtual characters could be combined so that the new virtual character expresses the complete set of configurations. Alternatively, the configurations of the virtual character configurations could be used to generate a substantially unique character with configuration properties based on the parent set of virtual characters.

Block S200, which includes executing the character S200, functions to apply the configuration for expressing the persona of the virtual character. Executing the character is preferably within a dynamic simulated environment, which may involve interactions with one or more user-controlled and/or computer-controlled characters. A character could be executed within a 2D or 3D simulated environment. The character could alternatively be executed as an audio or text based character. The character could be within a game or interactive environment but could similarly be used as a virtual assistant on a computer or within an application. Executing the character S200 can include receiving persona stimulus input S210 and generating a character response to the persona stimulus input and according to the configuration of the character S220.

Block S210, which includes receiving persona stimulus input, functions to detect or accept input from a user and/or a computer controlled system. The input could be text-based, audio-based, image-based, motion-based, or any suitable medium of input. The input is preferably used to alter the emotional and situational response of the virtual character. This response can preferably be dynamically adjusted to be consistent with the configured the virtual character. Emotional responses to the emotional state of another, body language, thought moments (i.e., pauses in dialog during thought and reactions to what the user says), distracted behaviors, personal quirks, cultural patterns, and/or persona-based traits can be integrated into rendering of the virtual character.

In one variation, receiving persona stimulus input can include processing text-based input. For example, a user may interact with a virtual character through a text-based chat program. The content of the text-based input can undergo sentiment analysis to determine the sentiment of the user providing the text.

In another variation, receiving persona stimulus input can include processing audio-based input. The audio may be speech delivered by a user. The spoken content could be processed in a similar manner as the text-based input. Additionally, the audio-based input could be analyzed to determine the state of the user based on voice properties. For example, the way a user is speaking may be used to determine if the user is angry, calm, frustrated, frightened, happy, impatient, or other characteristics. Text-based input and audio-based input may be processed in real-time such that thought AI driven responses of the character can be triggered during delivery. For example, a virtual character can preferably alter body language facial expressions, and or trigger other character responses as a person is talking to the virtual character.

In another variation, receiving personal stimulus input includes processing image-based input. The image-based input could be images of a user's face. Facial expressions, gaze analysis, and/or other attributes of the face may be used to determine the state of the user. The image-based input could alternatively be images of the user's body. The body language of the user could be detected and used as an input. Posture, hand gestures, and other forms of body language could be detected. As a similar alternative, the input could be a motion-capture input so that the motions of a user are measured directly.

In another variation, receiving personal stimulus input can include prosody recognition, which functions to analyze tonal qualities of audio-based input. The tone and timing of words can be processed and used to generate a stimulus input that reflects properties of those signals. Prosody recognition may be used in detecting a statement, question, command, irony, sarcasm, emphasis, contrast, focus, frustration, anger, fear, curiosity, happiness, and the like. “Tone” or sentiment recognition techniques could similarly be used for text-based input, which may use word choice, text formatting, emoji-usage, punctuation, typing rate, and/or other factors to interpret tone.

Additionally or alternatively, block S210 could include other forms of input. For example, biometric inputs that provide information on heart rate, body temperature, and other properties could similarly be used.

Block S210 may additionally include corroborating multiple stimulus inputs and generating a resulting stimulus input, which functions to interpret inputs in the context of two or more inputs. Communicated content in text and speech, facial and body language, prosody, and biometric signals can all be used to determine an overall stimulus input. This may be applied to obtain a more accurate interpretation of someone's true state. For example, if a user says “I'm Happy”, but their face looks sad and their voice sounds sad, the method generate personal stimulus input for the emotion that is most weighted—in this case “Sad”.

Block S220, which includes generating a character response to the persona stimulus input and according to the configuration of the character, functions to dynamically express the persona based on how the virtual character is configured to respond to the inputs. The virtual character configuration is preferably used to set the manner in which a virtual character is engaged. An additional response engine may generate all or part of the content delivered by the character. The types of attributes that are expressed preferably compliment the inputs. For example, if the input indicates a user is mad and frustrated, the virtual character may be configured to respond with a soothing and empathetic delivery of a spoken response. In one variation, the method supports receiving the virtual character response content and rendering it with the attributes of the virtual character. Generating a character response can include generating rigging animations, which can be used to set or augment how a virtual character moves and is animated. Generating a character response can additionally include modulating generated spoken response. For example a text-to-speech engine used by the virtual character could be modulated to alter the speech properties. For example, the speaking rate, tone, volume, and/or other properties may be altered. Such modulation of generated speech can apply emotional prosody and timing to correspond to appropriate character response. In one implementation, pitch shifting (e.g., auto-tuning) and time-shifting (e.g., auto-timing) can be applied on a synthetic voice to match a target emotional melody and timing. Additionally, spoken or text based content could be augmented through sentiment-balancing wherein the phrasing and/or word choice is augmented to target a particular sentiment.

As mentioned above, a character response to the personal stimulus input can be continuously applied, which can function to enable mid-statement responses and an appropriate transition of responses. Character responses are preferably modified in real-time to reflect the appropriate reactions as the virtual character receives input. For example, the method may apply active listening in Block S210 to detect key emotional words or triggers while a user is speaking. These key words or triggers can drive a character response in the form of “emotive listening”. A virtual character my non-verbally respond as the user is speaking. For example, if a user were to say “I won the lottery today while I was at the store”. The method may trigger a surprise character response on detecting the word “won” and then a happy character response on the subsequent word “lottery”.

Additionally, pre-set responses such as pre-recorded audio or animations could be triggered. Pre-set responses may be inserted within normal delivery. For example, a pre-set response could be triggered during a thought moments or moments of distraction. In some cases, pre-recorded messages may be desirable for various applications, but it can be time intensive to capture various emotional response variations of each pre-recorded message. Accordingly, pre-recorded or generated emotional response segments can be used as a “bookend” to playing pre-recorded media, wherein an emotional response segment can be played or presented leading into a pre-recorded message, spliced into a pre-recorded message, or after a pre-recorded message.

### 3. System for Generating a Virtual Character

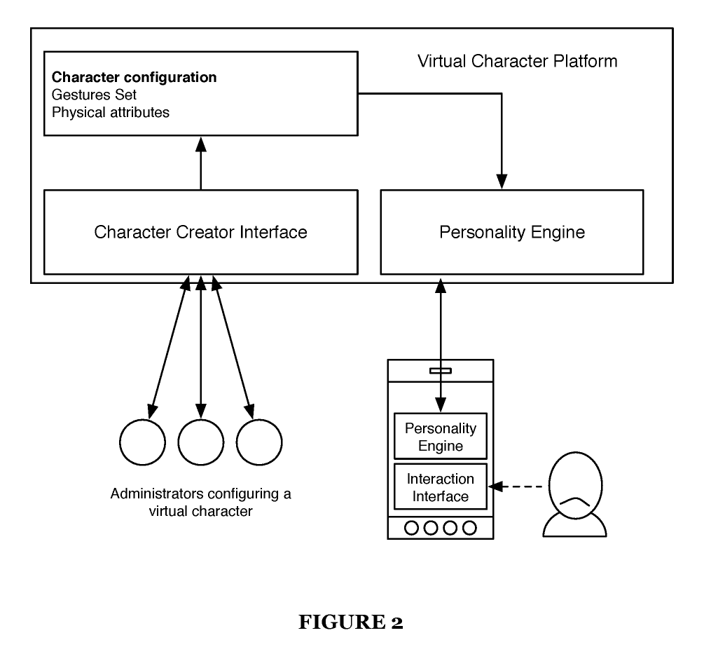

As shown in FIG. 2 a system for generating a virtual character of a preferred embodiment can include a character creator interface, interaction interface, and a personality engine. The system functions to enable customizable virtual character personas to be configured, customized, and otherwise created. The virtual character customizations can then be used in combination with inputs from the interaction interface to alter the expression of some intent of a virtual character. For example, an airline may build an automated customer support agent. The agent is used to deliver a particular set of content to the user. The system can be used to augment the delivered content such that it is expressed through a virtual character with potentially more perceived depth and human quality responses as opposed to responding blindly with general canned responses. Additionally, the system could adjust the response of the virtual character to the subject(s) interacting with the virtual character. The system is preferably used to implement the method described above, but any suitable system may alternatively be used with the method.

The system preferably leverages the various approaches for simulating emotional and thought based expression of a character described in the method above. In one implementation, the system can facilitate emotion sensing that tells the system what a user or other character is saying and feeling. That sensing input is preferably used in an active listening mode where character reactions are updated responsively. The sensing data also drives the thought AI that can drive the gestures and responses of the virtual character. The gesture set can be partially defined by a character archetype and configuration. The character configuration can then alter mood processing for the virtual character (e.g., a virtual character's simulated emotional response), and this mood may be used to instruct a prosody-driven speech output of the virtual character.

The system could be implemented as an application or development kit. As a development kit, the system can be used within third party applications to partially drive a virtual character. The system may additionally or alternatively be implemented through a virtual character platform. The virtual character platform is preferably a network accessible platform used for virtual character customization and management. The virtual character platform may be accessible over the internet by a browser application, native application, or programmatic interfaces. The virtual character platform could be multitenant such that multiple, independent entities could create and customize virtual characters on the virtual character platform. The virtual character platform could be a central host of virtual character customization.

As a multitenant platform, multiple distinct entities may use the platform for character customization. Parts or all of the virtual character customizations from different entities may be utilized to drive other customizations. For example, analytics and trends in virtual character customizations could be monitored and used to generate platform provided virtual character attributes. The platform could enable automatic rollout of enhancements to existing virtual characters.

The character creator interface functions as a user interface for creating and editing a virtual character. Various administrator features could be offered through the character creator interface. For example, multiple accounts could collaborate on the virtual character, permissions could be set to limit the interactions of accounts, version control could be enabled, sharing options, and/or other collaboration features could be enabled.

The interaction interface and the personality engine functions to dynamically express a configured character based on the current situation. The interaction interface can collect and characterize a variety of types of inputs including text-based input, audio-based input, facial expression input, body language input, prosody input, and/or other forms of input. The input is used to determine the type of response by a virtual character. The personality engine can drive virtual character behavior for one or more mediums. The personality engine or engines could be used to set the content delivered by a virtual character, the verbal properties of delivering content, the facial expressions of a visual character, the body language of a visual character, and/or any suitable aspect. The personality engine is preferably drives dynamic response to a set of character stimuli. The personality engine can alternatively be used for static generation of character expressions. For example, the personality engine may be used for procedural generated content in animated video production. The personality engine could be a deployable mechanism. For example, the system could output a virtual character configuration object that can be stored locally and used by locally executed application. Alternatively, part or the entire personality engine may be executed in connection with a remote, cloud-hosted platform.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

What is claimed is:

1. A method for generating a virtual character comprising the steps of:
defining the properties of the virtual character; and
applying said defined properties to the virtual character;
wherein the step of defining the properties of the virtual character comprises the substeps of:
defining a set of default virtual character attributes;
defining one or more gesture sets;
defining a set of verbal traits; and
defining a set of physical attributes; and
wherein the step of applying said defined properties to the virtual character comprises the substeps of:
receiving persona stimulus input from a user; and
generating a virtual character response to the persona stimulus input in accordance with the defined properties of the virtual character.

2. The method of claim 1 wherein the properties of the virtual character are defined by reference to the properties of a second virtual character.

3. The method of claim 1 wherein the set of default virtual character attributes comprises a plurality of personality attributes, wherein each personality attribute is assigned a numerical value.

4. The method of claim 1 wherein each gesture set comprises one or more visual actions comprising a rigging specification performed by the virtual character, and wherein each visual action is assigned to a defined emotional mood or situation.

5. The method of claim 1 wherein the set of verbal traits comprises one or more scripted response phrases.

6. The method of claim 1 wherein the set of verbal traits comprises vocalization response properties.

7. The method of claim 1 wherein the step of receiving persona stimulus input from a user comprises receiving text-based input.

8. The method of claim 1 wherein the step of receiving persona stimulus input from a user comprises receiving audio and visual input.

9. The method of claim 1 wherein the step of generating a virtual character response comprises:
selecting a spoken response;
modulating the speaking rate, tone, and volume of the spoken response; and
playing the spoken response as audio.

10. The method of claim 1 wherein the step of generating a virtual character response comprises generating one or more rigging animations and animating the virtual character with the one or more rigging animations.

11. A system for generating a virtual character comprising:
a character creator interface;
an interaction interface; and
a personality engine;
wherein the character creator interface is configured to provide a graphical user interface for defining properties of the virtual character comprising a set of default virtual character attributes, one or more gesture sets, a set of verbal traits, and a set of physical attributes;
wherein the interaction interface is configured to receive persona stimulus input from a user; and
wherein the personality engine is configured to generate a virtual character response to the persona stimulus input in accordance with the defined properties of the virtual character.

12. The system of claim 11 wherein the set of default virtual character attributes comprises a plurality of personality attributes, wherein each personality attribute is assigned a numerical value.

13. The system of claim 11 wherein each gesture set comprises one or more visual actions comprising a rigging specification performed by the virtual character, and wherein each visual action is assigned to a defined emotional mood or situation.

14. The system of claim 11 wherein the set of verbal traits comprises one or more scripted response phrases.

15. The system of claim 11 wherein the set of verbal traits comprises vocalization response properties.

16. The system of claim 11 wherein the persona stimulus input comprises text-based input.

17. The system of claim 11 wherein the persona stimulus input comprises audio and visual input.

18. The system of claim 11 wherein the virtual character response comprises a spoken response, and wherein the personality engine is configured to modulate the speaking rate, tone, and volume of the spoken response and play the spoken response as audio.

19. The system of claim 11 wherein the virtual character response comprises one or more rigging animations, and wherein the personality engine is configured to animate the virtual character with the one or more rigging animations.

20. A method for generating a virtual character comprising the steps of:
defining a set of default virtual character attributes comprising a plurality of personality attributes, wherein each personality attribute is assigned a numerical value;
defining one or more gesture sets, wherein each gesture set comprises one or more visual actions comprising a rigging specification and performed by the virtual character;
defining a set of verbal traits comprising one or more scripted response phrases and vocalization response properties; and
defining a set of physical attributes;
receiving persona stimulus input comprising audio and visual input from a user;
selecting a spoken response to the persona stimulus input;
modulating the speaking rate, tone, and volume of the spoken response in accordance with the defined virtual character attributes, gesture sets, verbal traits, and physical attributes;
playing the spoken response as audio; and
generating one or more rigging animations and animating the virtual character with the one or more rigging animations in accordance with the defined virtual character attributes, gesture sets, verbal traits, and physical attributes.
